(19) United States
(12) Patent Application Publication
(10) Pub. No.: US 2019/0303924 A1
(43) Pub. Date: Oct. 3, 2019

(54) AliasIdentity: The Payment Invention

(71) Applicant: GARY J. KNORR, NORTH LIBERTY, IA (US)

(72) Inventor: GARY J. KNORR, NORTH LIBERTY, IA (US)

(21) Appl. No.: 16/446,330

(22) Filed: Jun. 19, 2019

Related U.S. Application Data
(63) Continuation-in-part of application No. 14/622,863, filed on Feb. 14, 2015.

(51) Int. Cl. G06Q 20/38; G06Q 20/36; G06Q 20/10; G06Q 20/40; G06F 21/62

(52) U.S. Cl. CPC G06Q 20/385; G06Q 20/3674; G06F 21/6254; G06Q 20/4016; G06Q 20/102

(57) ABSTRACT

A payment system can include removal from the Grid (electronic network) of a person's identity for the purpose of purchased transactions. The payment system can use a Digitized 2D Graphical representation of the person's “Alias Identity” for the purpose of identification and authorization of a purchase transaction. The system can store securely off an electronic network a personal identity for a payment process. The payment system can process a payment in a secure manner and forward it to a merchant.

This application is a continuation in part of application Ser. No. 14/622,863 filed Feb. 14, 2015. The Invention relates generally to the field of electronic payment systems.

### FIELD OF THE INVENTION

### Background of the Invention

Today, it is almost a daily occurrence that companies that are accepting payments, large and small, and are reporting identity theft of their customers.

The hackers are hacking the company's systems to steal consumer's identity. The identity theft disrupts the payment processing chain and all the participants in the chain are harmed financially and structurally.

There is a need for a company to create a payment system that will remove the consumer's identity by creating a Alias Identity for the consumer off the grid, while providing a secure, efficient and cost affective financial transaction using the consumer's Alias Identity. The Invention is not a consumer's registration method instead it is a Identity Removal method and a Off the Grid payment system with a Alias Identity for the consumer's transaction

Companies today try to prevent identity theft after it occurs, or they make the merchant responsible for accepting fraudulent transactions by the means of a charge back when they occur or the bank that is responsible for replacing stolen money into the customer's account when money goes missing from identity theft. The consumer is also left picking up the pieces from these fraudulent transactions spending hundreds to thousands of dollars to fix the identity theft.

### SUMMARY OF THE INVENTION

In one aspect of the present invention, a method of encrypting an identity for financial transactions includes creating an alias for the identity on an alias computer server with both a graphical component and a textual component, creating a hardware firewall between an internet server and the alias computer server; creating a software firewall between the internet server and the alias computer server; creating air gaps between the internet server and the alias computer server; utilizing the Alias Identity in financial transactions with a financial institution; creating the graphical component as a proprietary 3² token; sending the 3² token with a mobile device to a merchant; displaying the first elements of the Identicon. The second element of the Identicon is displayed when the merchant scans the 3² token. Then the system displays the consumers photo; and the merchant visually verifying the consumer with their photo and then approving the financial transaction..

In another aspect of the invention, a system of encrypting an identity for financial transactions includes an alias computer server configured to create an alias for the identity with both a graphical component and a textual component; an Alias server configured to encrypt splinters of information from random events through a plurality of electronic devices; a hardware firewall between an internet server and the threat computer server; a software firewall between the internet server and the threat computer server; and a plurality of air gaps between the internet server and the alias computer server.

In another aspect of the present invention, a system of encrypting an identity for financial transactions including an email server configured to collect information regarding the identity; an alias computer server configured to create an alias for the identity with both a graphical component and a textual component, an alias server configured to encrypt the alias with splinters of information from random events through a plurality of electronic devices; a hardware firewall and a software firewall disposed between an internet server and the threat server; a transaction server configured to complete a financial transaction request received from the alias server; and at least one air gap between the internet server and the threat server, and at least one air gap disposed between the alias server and the transaction server.

These features are described further in the description below, in the drawing, and in the claims.

### DESCRIPTION OF THE FIGURES

FIG. 1 is a flowchart of the invention.

FIG. 2 is a customer purchase process according to an embodiment of the invention.

FIG. 3 is a mock up of an application landing page according to an embodiment of the invention.

FIG. 4 is a mock-up of a merchant list screen according to an embodiment of the invention.

FIG. 5 is a mock-up of a payment code screen according to an embodiment of the invention.

FIG. 6 is a mock-up of a customer confirmation screen according to an embodiment of the invention.

FIG. 7 is a mock-up of a merchant search screen according to an embodiment of the invention.

FIG. 8 is mockup of a merchant map screen according to an embodiment of the invention.

FIG. 9 is a mock-up of a merchant map screen with pop-up according to an embodiment of the invention.

FIG. 10 is a mock-up of “My Wallet” option according to an embodiment of the invention.

FIG. 11 is a mock-up of a reports page one according to an embodiment of the invention.

FIG. 12 is a mock-up of a reports page two according to an embodiment of the invention.

FIG. 13 is a mock-up of a reports page three according to an embodiment of the invention.

FIG. 14 is a mock-up of a settings menu according to an embodiment of the invention.

FIG. 15 is a mock-up of Notifications Settings according to an embodiment of the invention.

FIG. 16 is a mock-up of a low balance alert screen according to an embodiment of the invention.

FIG. 17 is a mock-up of a My Profile settings menu according to an embodiment of the invention.

FIG. 18 is a mock-up of an About Menu according to an embodiment of the invention.

FIG. 19 is a mock-up of an Agreements Menu according to an embodiment of the invention.

FIG. 20 is a mock-up of a Feedback Option screen according to an embodiment of the invention.

FIG. 21 shows a USB Hub between a Threat Server and a mechanical robot.

FIG. 22 shows a USB Hub between a mechanical robot and an Alias Process Server.

FIG. 23 shows a USB Hub between an Alias Process server and a mechanical robot.

FIG. 24 shows a USB Hub between a mechanical robot and a transaction process server.

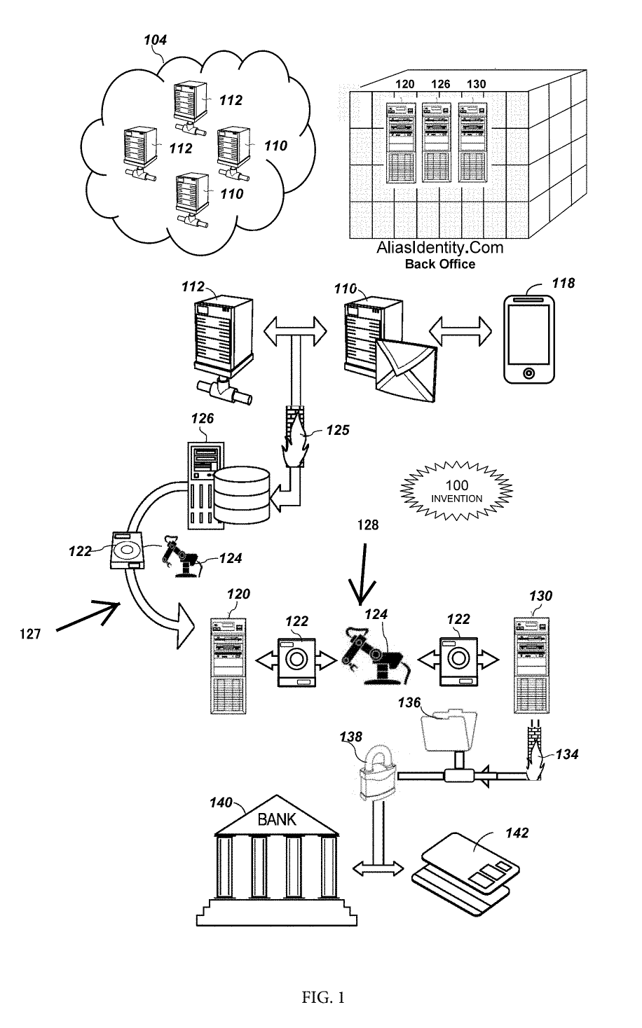

### DETAIL DESCRIPTION

Parts of the invention are labeled as follows:
104—Internet
110—Internet Mail Server
112—Internet Exchange Server
120—Alias Process Server
122—USB Hub
124—Mechanical Robotic Device
126—Threat Server
127—First Air Gap
128—Second Air Gap
129—USB drive
130—Transaction Process Server
134—Firewall
136—FTP Site
140—Bank
142—Customer credit card account.

The Mail Server (Connected to the Internet) as Part of the Invention

The internet mail server (110) is important to the invention because it is the query server for all the splinters of information when directed by the alias server to gather an additional splinter of information from the consumer. The internet mail server (110) is like an “in and out” box for randomly gathered information. It is the first level of protection when gathering information. Information sent from and to the consumer is done through a secure environment with a 256 bit encryption protocol and is protected by “off the shelf” security system and hardware firewall. At the time of the transaction request by the Internet Mail Server (110), the consumer has been given an Alias(Key Code) by the Alias Process Server (120). The consumer is not identified in any transactions as a “real” person. They have become a number with no identity thus protecting their identity. The person will know that the information being requested is meant for them by their visual Identicon. If the Identicon is lost or stolen it can be re-created without harm to the consumer.

Information found on the Internet Mail Server (110) from the internet (104) in a splinter might be expressed like the following example: (Key Code) Cedar Rapids, Iowa Once this piece of information has been off loaded through the system through the Server, the Alias Server may request an additional splinter of information (Key Code) 52402, the Alias Server may request an additional splinter of information (Key Code) 600 Blairs Ferry, and the Alias Server may request an additional splinter of information (Key Code) 1234567 (aba number). Once these randomly collected pieces of information are collected, they are transferred to the Alias Process Server (120) one at a time with the Key Codes and then processed through the second Air Gap (128) and end up on the Transaction Process Server (130). An identity is created for the person who originally had their Identicon with their name, email address and photo transmitted through the Internet Exchange Server (112) so it would look as follows at this point on the Transaction Process Server (130).

The Exchange Server (Connected to the Internet) as Part of the Invention

The Exchange Server (112) serves two functions within the process. First, the Exchange Server (112) is where the internet company resides and is marketed from. Marketing is done to financial institutions that become the vehicle for the process, merchants who become the access point to the process and the consumer who chooses to use the process to protect their identity with the merchant through the financial organizations.

The invention seeks to resolve the issues of identity theft before it occurs by creating a digital representation of the customer that replaces the customer's identity with an “Identicon”. The “Identicon” will become a graphic representation of the customer in a one time payment authorization that the merchant can securely take and transmit for secure payment into their deposit account.

The “Identicon” can make payment to the merchant either in cash through a deposit account or via credit card that is authorized by the bank (140) to the customer. The “3² token” is good for a one time only transaction on the consumer's smart phone. Once a transaction is complete and authorized by the processing center the transaction is complete and our propriety 3² token cannot be regenerated or reused at any other merchant. The authentication is authorized by the consumer and verified by the merchant by visually matching identity of the customer through a photo match of the customer via the system sent to the merchant's home page on the exchange server (112).

The Exchange Server (112) acts as a sign up mechanism between the consumer and the Financial Institution. The payment processes which our servers perform are unique to our invention. Access to this payment process is dependent upon the consumer having a relationship with a member Financial Institution. The Exchange Server (112) makes this possible either by the Financial Institution signing up the consumer or the Exchange Server (112) matching a consumer to a member Financial Institution. This relationship is important to the system because it is where we capture the image for the Identicon and verify that image through the system by the Financial Institution verifying the person's identity with multiple forms of identification and creating an account relationship with the consumer. The account relationship can be a checking or savings account extending by the Financial Institution with a line of credit attached to it or it can be a credit card issued by the Financial Institution with a line of credit attached to it. Either way, this will enable the consumer to make a secure purchase from a member merchant.

The consumer's picture which becomes the foundation of the Identicon is taken at the Financial Institution at the time of sign up and is transmitted as a splinter of information through the system to reside on the transaction process server (130).

Examples of data splinters first request are name and email address. This is generated as part of our internet marketing site. Name and Email Address of the consumer are provided by them through the financial institution or direct by the consumer on our site.

### The Threat Server as Part of the Invention

The first line of defense in the collection and securing of the customer's splinters is the Threat Server (126). The purpose of the Threat Server (126) is to collect incoming information from the Internet Servers and examine the incoming information for viruses, malware, malicious intrusion, spam, etc. The process uses a combination of off the shelf programs and third party companies to examine the incoming data. The incoming data is batched onto a USB drive (129) and follows the steps and the creation of the Customers Alias Identity.

The Threat Server (126) is also attached to the first of, for example, Acroname® Programmable USB 3.1 hubs which act as the gatekeeper for the first firewall (125) that is controlled by Brainstem Software Controller and a Mechanical Extraction and Mechanical Robotic Device (124).

### Creation of the Customers Alias Identity

The customer is sent an email to join by participating Bank (140) or Merchant by Internet Exchange Server (112)

If the customer chooses, the customer enters Name and Email Address Only and checks the acceptance of the terms of condition.

The customer's name and email address are stored in a data base on the Internet Exchange Server (112)

The data base accepts multiple customers until a call is made by the Alias Process Server (120)

The call batches the new customer data base, and this starts the process of creating an Alias identity for each customer

The batch is transmitted through the Fire Wall (125) and is deposited on the Threat Server (126)

Each batch on the Threat Server (126) is examined by intrusion software for viruses, malware, etc.

Once the batch is completely examined and marked clean, it is sent to a usb drive (129) on the USB hub (122).

The batch is sent through the Up1 connection to the hub which is unidirectional because of hardware restrictions. The hub only support bidirectional movement by the BrainStem controller.

The batch is stored on one of the usb drives (such as 129) inserted into one of D4-D7 extraction ports and is awaiting extraction and insertion onto one of the D0-D3 insertion ports on the usb hub (122) attached to the Alias Process Server (120)

Alias Process Server (120) calls for the mechanical extraction of one of the usb drives (such as 129) on the USB hub of the Threat Server (126).

The usb drive (129) is extracted using Mechanical Robotic Device (124) and inserted into D0-D3 insertion ports on the Alias Process Server (120) USB hub

The information is then called to be exported through Up0 the up load port to the Alias Process Server (120)

The Alias Process Server (120) creates an encryption key for each of the new customers. The key will be a part of all calls for additional customer splinters of information about the customer such as address, city, state, zip code, etc (where there are 10) until the ten splinters of the customer attributes are accumulated on the Transaction Process server (130).

The creation of a customer's splinters starts with the Alias Process Server (120) issuing a call to the Internet Mail Server (110) for a splinter of a customer attribute.

Internet Mail Server (110) generates one of the calls for information from the customer, examples; the first request is always for the customer's phone number via email. This is done so that the system has a second form of communication with the customer for future requests for customer splinters.

Then a request of address by a text message to the customer, for a portion of their address such as address or city or state or zip code. These requests for additional splinters can now be done through texts messages or emails as the Internet Mail Server 110 may request these randomly. The internet mail server (110) attaches the customer key to each piece of information

As the customer complies and sends back the information, the Internet Mail Server (110) sees the key and appends the key with a descriptor of the information and encrypts the piece of information to send to the Alias Process Server (120).

The information is batched for transmission to the Alias Process Server (120).

The batch is transmitted through the Fire Wall (125) and is deposited on the Threat Server (126).

Each batch on the Threat Server (126) is examined by intrusion software for viruses, malware, etc.

Once the batch is completely examined and marked clean, it is sent to a usb drive (129) on the USB hub (122).

The batch is sent through the Up1 connection to the hub which is unidirectional because the hub does not support bidirectional movement.

The batch is stored on one of the usb drives (such as 129) inserted into one of D4-D7 ports and is awaiting extraction and insertion onto one of the D0-D3 ports on a usb hub (122) attached to the Alias Process Server (120)

Alias Process Server (120) calls for the mechanical extraction of one of the USB drives (such as 129) on the USB hub (122) of the Threat Server (126).

The usb drive (129) is extracted using Mechanical Robotic Device (124) and inserted into D0-D3 on the Alias Process Server (120) usb hub (122).

The information is then called to be exported through Up0 to the Alias Process Server (120)

The Alias Process Server (120) collects the information for each customer until all 10 of the splinters for the customer is collected.

As the splinters of the customer attributes are collected they are systematically removed from the Alias Process Server (120) and stored with their unique key code on the Transaction Process Server (130) through the second Air Gap (128) as follows:

The Alias Process Server (120) tracks random information with key codes from multiple customers. It sends the splinters of information through Up0 to one of USB hub (122) D4-D7 for extraction and removal to the Transaction Process Server (130). It does not allow more than one splinter of one customer's attributes to be stored on the same usb drive (129) to be transmitted to the Transaction Process Server (130).

Once a drive is 80% full, the Alias Process Server (120) sends a call to the mechanical removable robot (124) to remove the usb drive (129) and insert it into D0-D3 on the Transaction Process Server's USB hub (122).

The Transaction Process Server (130) continues to collect all ten attributes of a customer until the customer's identity is all stored off the internet and secured behind the Invention which includes the two Air Gaps (127, 128) with two mechanical removal robotic devices (124)

The Alias Process Server as Part of the Invention

The Alias Process Server (120) is the hub of the Invention. It is where the Alias Identity is created and stored. The Alias Process Server (120) also is where the calls are generated to create the Alias Identity and it is the gate keeper for the Transaction Process Server (130).

The Alias Identity Creation:

The creation of the Alias Identity is The Invention and the ability to keep this Alias Identity off grid by the Process yet let the Alias Identity make normal transactions in the real world is the key to the Invention and the Process.

The Alias Process Server (120) gathers information by creating calls. The calls are for Splinters of information. The Alias Process Server (120) sends these calls through the Process to the Threat Server (126) then to the Internet Mail Server (110) from behind our first Air Gap (127). The ten calls of information create the Alias Identity but the Alias Process Server (120) stores a specific set of information that is proprietary to our system. This set of information is coupled with the real world's physical picture of the consumer and a 3² Color code is created for use by the Exchange Server (112) to authenticate the consumer to the merchant or financial institution.

The Alias Server assigns a unique cipher to the Alias Identity which is used by the Threat Server (126) when creating the HMAC-SHA512 code. The cipher, when created by the Alias Server, is also passed to the transaction Server through the second Air Gap (128). This one time cipher, for the Alias Identity, is used by the Alias Process Server (120), to create the data base of encrypted data coming from the Threat Server (126). Once the cipher is created once and stored in the data base, it is never used again for any other Alias Identity, so as the information travels through the system and the process, random information can be paired and synchronized in the Alias Process Server (120) for transmission through the second Air Gap (128) to the Transaction Process Server (130).

Generating the Calls:

The Alias Process Server (120) generates random calls for the ten Splinters of Information that are required to create the consumer behind the second Air Gap (128) on the Transaction Process Server (130). To further protect the Transaction Process Server (130), the calls are generated by creating chaos in the collection of the Splinters of Information through to the Internet Mail Server (110). Example:

| johndoe@hotmail.com | janedoe@yahoo.com |
|---|---|
| John Doe | Jane Doe |
| City | Account Number |
| Address | Credit Limit |
| State and Zip Code | City |
| Credit Limit | Credit Card Number |
| Phone Number | Address |
| Password | Phone Number |
| Account Number | State and Zip Code |
| Credit Card Number | Password |

By collecting information randomly with no synchronization except for the cipher that was uniquely created for each of these, as these Splinters of Information are randomly called and encrypted, anyone wanting to hack the information would get chaos within the data that they would hack, steal and gather because there is no association between the Splinters of Information and the consumer until that information is constructed behind the second Air Gap (128) on the Transaction Process Server (130).

The Alias Process Server (120) is the data base for the Alias Identity. The Alias Identity, after it is created, resides on the Alias Process Server (120). Each Alias Identity is unique because of the data that is randomly selected to be stored with it. The data stored with each Alias Identity creates the cipher with the key that is passed to the Alias Process Server (120) to create the connection between the real world person, which will be stored on the Transaction process Server (130) and the Alias Identity.

### Example

| johndoe@hotmail.com | janedoe@yahoo.com |
|---|---|
| John Doe | Jane Doe |
| City | Account Number |
| Address | Credit Limit |

Based on the character length of the two preceding examples and the information the Alias Identity's are created. As you can see, they each are different and unique when compared to the real world person. Splinters of information will match once encrypted and allow for the match to be perfect each time a transaction is created. The extra security that is part of the Alias Identity file in the Alias Process Server (120) is the photo obtained in the process of creating the Alias Identity. The photo, when matched with the Splinters of information above and presented to the merchant at the time of the financial transaction.

Once the Alias Process Server (120) creates the Alias Identity, it is exported out to be stored on the Exchange Server (112). Once stored on the Exchange Server (112) the consumer can ask for a Identicon as a token for authentication of a financial transaction by merchants.

When a call is issued by a merchant the Identicon is sent for authentication of the transaction. The Identicon is unique to the invention it is made up of three components which are stored or generated on the Exchange Server (112)

The Identicon has a graphical component (our proprietary 3² Code), a textual component the Transaction Number created for a merchant reference and a Photo of the customer for verification of customer present by the merchant. (photo is presented to the merchants point of sale device).

When the transaction occurs the merchant accepts the 3² Code as authentication token for the transaction. As the merchant scans with any web enabled camera the 3² code on his internet connected system the merchant will see the customer on the merchant's monitor and the merchant will authenticate the customer, thus accepting the unique transaction code stored one time within the 3² code.

The 3² code is constructed form three rows of three dots in each row the internet exchange generates this transaction code which is associated with a unique alpha numeric code attached to each color the merchants web camera reads the pattern of color if they match code generated by the exchange server (112) than the merchant is sent the consumers photo for verification.

Creation of the Financial Transaction

Once all the attributes (splinters) are captured and stored on the Transaction Process Server (130) the system sends a request to the customer to provide a photo of the customer to the system. The customer can do this by going to the financial institution or a merchant that invited the customer to join the system. The customer cannot proceed to purchase until the photo of the customer is part of the data base on the Transaction Process Server (130).

The Bank (140) or Merchant can go to EZGOPAY web site to collect the photo of the consumer. Choose add photo enter customer's email address to find customer verify with customer photo ID. Then use any web enable camera to capture photo and add to the Internet Exchange Server (112) and send thru the system to the Transaction Process Server (130) once the photo is a part of customer profile the system will send an email to the customer that they can use EZGOPAY to purchase from member merchants.

Once the photo is part of the system the Transaction Process Server (130) stores on USB hub (122) D4-D7 for extraction and insertion into the Alias Process Server (120) D0-D3 a data base of approved customers including a photo to be sent through the system to the Internet Exchange Server (112).

The Alias Process Server (120) creates the Identicon for the Internet Exchange Server (112) for financial processing. The Alias Process Server (120) creates an alpha numeric key code which contains the original key code and specific characters from the customer's ten splinters of information. The information will be used to create the two dimensional graphical representation. This is then combined with the customer's photo and sent to the Internet Exchange Server (112).

The Alias Process Server (120) creates a batch of customers ready for use by the Internet Exchange Server (112). It exports the information through Up0 to D4-D7 for extraction by the Mechanical Robotic Device (124) to the Threat Server (126) which will then send the information to the Internet Exchange Server (112) for processing customer's financial transactions.

A fully registered consumer that has a photo on the Internet Exchange Server (112) as well as a textual component which is made up of the original key code and specific characters of information from the ten splinters that were collected randomly by the system and is used to generate the graphical component of the transaction is now ready to make a financial transaction with a participating merchant and/or bank (140).

When the customer chooses to make a financial transaction, he starts by going to his smart phone and the EZgopay application where he chooses to pay the merchant by EZGOPAY app. When he clicks on the pay now button on the EZGOPAY app, the Internet Exchange Server (112) sends to the customer's smart phone a two dimensional graphical representation for scanning by the merchant (this representation is three colored dots by three colored dots to form a random tic-tac-toe of a total of nine colored dots). The Internet Exchange Server (112) associates this graphical representation to the customer's key code.

The graphical representation is scanned by any web enabled camera (this eliminates the high cost of credit card machines for the merchants).

Once the graphical representation is scanned, the Internet Exchange Server (112) sends the photo associated with the consumer to the merchant's web enabled device. The merchant identifies the consumer by the photo and either accepts or rejects the financial transaction.

If the merchant accepts the financial transaction the system captures the merchant's transaction for processing by the Transaction Process Server (130) and the following elements are saved to authenticate the financial transaction.
a. The graphical representation of the customer approved by the merchant
b. The photo of the customer presented by the system the merchant
c. The key code associated with the graphical representation
d. The details of the financial transaction
e. The geo location of the financial transaction from the customer's cell phone (118) and the merchant's geo location to verify the transaction. This assures that the customer is at the merchant's location and helps prevent fraudulent transactions.

All this information is stored on the Internet Exchange Server (112) and is sent through the Firewall (125) to the Threat Server (126).

The Threat Server (126) checks all information from the transaction for viruses, adware, malware and intrusions.

Once the information is deemed clean, the Threat Server (126) sends to Port Up1, the information for storage and extraction on USB hub (122) D4-D7 ports. Once a USB drive (such as 129) is 80% full of financial transactions, the Mechanical Robotic Device (124) is instructed by the BrainStem Controller to remove the USB drive (129) and insert it into D0-D3 of the Alias Process Server (120).

The Alias Process Server (120) verifies the financial transaction components by matching the existing key code for the customer with the transaction key code. Once the transaction is verified, the Alias Process Server (120) exports the transactions to Up0 on the USB hub (122) which stores the transactions for extraction on D4-D7 by the Transaction Process Server (130). Once the USB drive (129) is 80% full, the BrainStem Controller triggers the extraction and insertion of the information by the Mechanical Robotic Device (124) to the USB hub (122) of the Transaction Process Server (130).

The Transaction Process Server (130) creates a financial transaction between the bank (140) and the merchant through a firewall (134) by using the customer's stored information.

In an embodiment, batch files can be created in a secure FTP 136 site. The Financial Institutions can be sent a key that corresponds with the batch number for their daily processing. One unique key can be generated for each financial batch sent to the Financial Institution. If five batches are created in a given period, five keys can be created for decryption of the batches. The batches can be sent to the FTP site for the bank (140) to pull. The bank (140) can randomly access the third party FTP site 136, identify a file, and download it the bank (140). The bank (140) can use an encryption key to decrypt and unlock a lock (138) on the file and complete a transaction with a customer credit card account (142).

The Transaction Server as Part of the Invention

The Transaction Server is used for the creation of the customer behind a plurality of secure USB hubs (122) and mechanical robotic devices (124) that are used to transmit splinters of customer information to the back office database contained on the Transaction Server. The ten splinters of information with encrypted keys are decrypted then assembled in the data base to create an off the grid real customer identity for processing financial transactions.

The Internet Exchange Server (112) has encrypted the transaction as verified by the merchant and authorized by the customer by their ezgopay app.

The Alias Transaction with its transaction code is converted into a financial transaction with the name and account number and personal information of the consumer and is transmitted through a secure VPN to the credit card processor or to the member bank (140) for the financial transaction.

Devices of the Air Gap

The Movement of Sanitized Data Using a Robotic Device Through the Air Gap

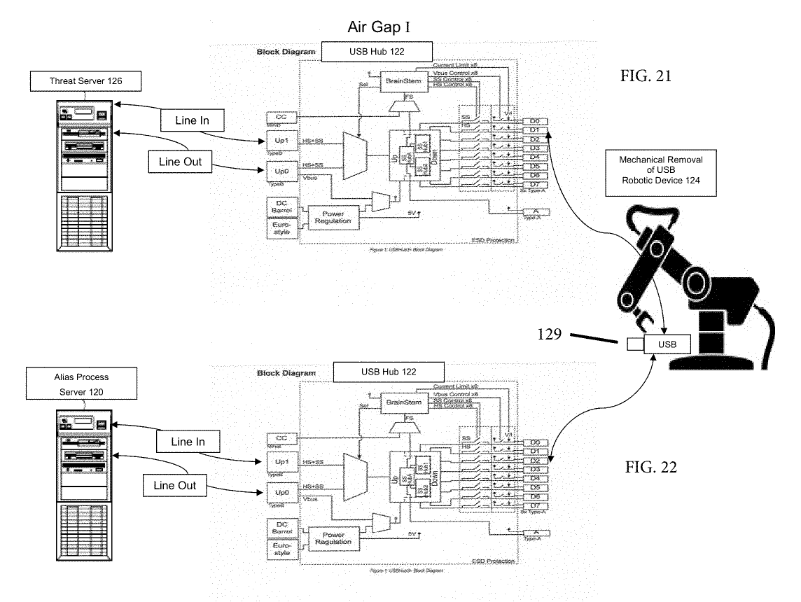

The Air Gap (127, 128) (See FIGS. 21-24) is made up of two components: a programmable hub (122), which is a programmable switch with USB ports to allow USB storage devices (129) to be inserted for storage then removed to transfer data over the air gap and then inserted to transfer data to the appropriate server. and a mechanical robotic device (124) to remove the usb drive (129) from the programmable hub (122). The usb drive (129) is inserted into or extracted from a programmable hub manufactured by, for example, Acroname®.

The movement of the usb drive (129) from one programmable hub (122) to another programmable hub (122) is accomplished by a programmable robot (UR3e) with an electrical or pneumatic gripper manufactured by, for example, Universal Robots® or an alternate TTR Table Top Robot®.

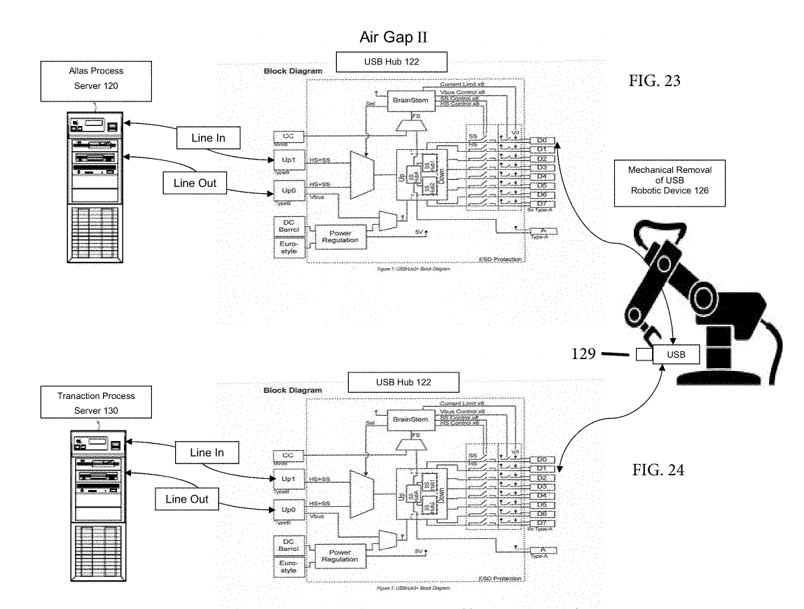

The sending device triggers movement of data over an air gap. For example, the Threat Server (126) triggers movement of data (such as an Identicon or other communication) over Air Gap I (127) (FIG. 21-22) to the Alias Process Server (120). The Alias Process Server (120) triggers movement of data (such as an Identicon or other communication) over Air Gap I (127) (FIG. 21-22) to the Threat Server (126). The Alias Process Server (120) triggers movement of data (such as an Identicon or other communication) over the Air Gap II (128) (FIG. 23-24) to the Transaction Process Server (130). The Transaction Process Server (130) triggers movement of data (such as an Identicon or other communication) over the Air Gap II (128) (FIG. 23-24) to the Alias Process Server (120).

Acroname® and the universal robots can be used because of their current technology. The concept of using a storage device and a robotic mechanical devices was always part of the invention. It is the unique programming of the collection and movement of data by a mechanical robotic device (124) like a robotic arm or an other robotic device to create the air gap (127, 128) is what gives our invention its uniqueness.

The information of having programmable data hubs and robotic arms as written by the manufacturer in their specifications exhibits the programmable devices are available to create our air gaps (127, 128).

The USB HUB

The USB Hub (122), can, for example, be the Acroname® USBHub3+ that is an 8-port software-programmable USB 3.1 (Gen1l 5 Gbps) hub that is designed for demanding industrial environments where advanced control and monitoring of USB ports is required. This is very useful in demanding environments where “always-on” behavior of a consumer-grade USB hub (122) is not desirable.

Software control of the USBHub3+ can be established and maintained over the selected one of the two available host-facing ports or the dedicated Control Port connection. The USBHub3+ can be used to enable/disable individual USB ports, measure current or voltage on downstream USB ports, set programmable current limits, set USB charging protocol behavior and otherwise automate USB port behaviors

Customer Mobile Application

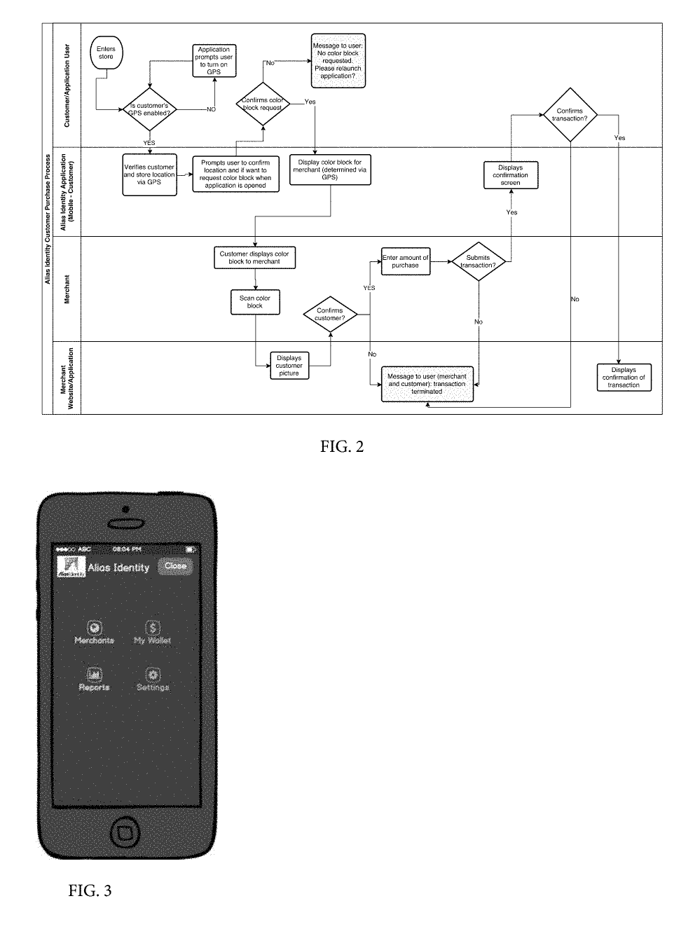

FIGS. 3-20 show mobile cell phone screens according to an embodiment of the invention. A Customer Application must require the same username and password as the web application. See also FIG. 2, the Customer Purchase Process.

Once logged in, the user remains logged into the application until the program releases the device or the transaction closes or the user manually logs out.

A “Forgot Username or Password” option will be available on the login page.

The “Forgot Username or Password” function must function the same as the function on the website.

The application will be available to operate on Android or Apple devices.

When the application is open (even if not the active application), it searches for nearby merchants based upon the GPS location of the phone.

When a customer's application is open (active window) and the GPS on the phone is not enabled, a notification must pop up to the user to “Turn on GPS to locate nearby merchants accepting Alias Identity payments or search using zip code.” The notification allows the user to open their settings or dismiss the notification.

The landing page of the application provides the following options:

### Merchants

### My Wallet

### Reports

### Settings

Mock up of the application landing page is shown in FIG. 3.

When a customer's application is open (even if not active or if the phone is locked) and they are near a merchant that accepts Alias Identity, the application generates a notification stating: “You're close to [Merchant Name]. Open Alias Identity to complete a purchase.”

If the user clicks on the notification generated above, the application opens when the phone is unlocked. If the phone is locked, the method to unlock must pop up and once unlocked, the application should be open.

The notification can be disabled through the Settings (See Settings Option below) menu, but by default is enabled.

All pages in the application must have a header with the following information:

### Alias Identity Logo

### Option Selected

Back or Close button depending on the page.

All pages, except the application landing page, has the display links to the options that the user is not currently in. See table below.

| Option User is | 1^{st} Option in | 2^{nd} Option in | 3^{rd} Option in |
|---|---|---|---|
| Currently Using | Footer | Footer | Footer |
| Merchants | My Wallet | Reports | Settings |
| My Wallet | Merchants | Reports | Settings |
| Reports | Merchants | My Wallet | Settings |
| Settings | Merchants | My Wallet | Reports |

The application will not rotate when the user rotates their phone. The direction of the application is always vertical.

Merchants Option

When the user selects the Merchants option from the landing page OR when the user opens the application from the notification mentioned above, a new page in the application opens displaying the merchants within a selectable radius of the users' GPS location or within the mile radius of the zip code entered.

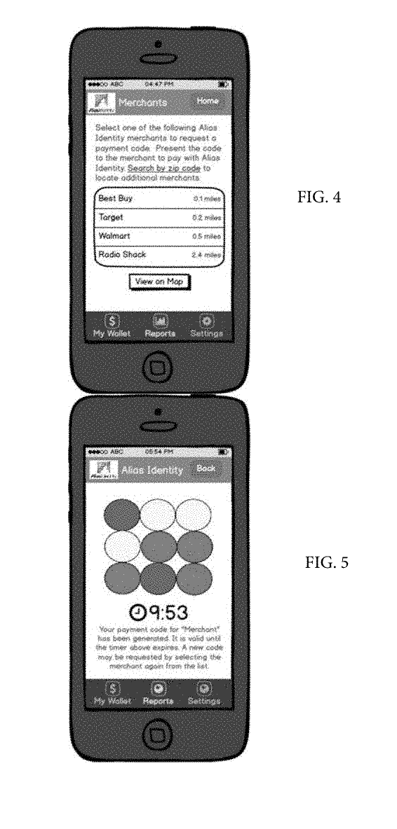

Mock up of the Merchant List screen: See FIG. 4.

If the user selects the Merchant option and there are no merchants nearby, an error message pop-up stating “There are no merchants nearby that accept Alias Identity. Please try again later.”

When the user selects a merchant from the Merchant list (CMM01), the payment code is displayed.

The payment code screen provides a temporary, time-limited purchase code.

The payment code screen displays a timer that is active and counting down to zero.

The text below the payment code states: “Your payment code for [Merchant] has been granted. It is valid until the timer above expires. A new code may be requested by selecting the merchant again from the list.”

A back feature must be provided on the payment code screen. This would return the user to the merchant list screen.

Mock up of Payment Code Screen: See FIG. 5.

If the user uses the back button and selects the same merchant again, a new code is generated with the time reset. In this scenario the previous payment code is cancelled and no longer available.

This also means if the user leaves the page with the live payment code (live meaning active with running timer), the payment code is cancelled.

Leaving the page is defined as selecting the Back button.

Leaving the page is defined as switching to another screen within the Alias Identity application.

Leaving the page is NOT defined as switching applications, locking the phone or selecting the phone's home button.

When the timer expires, the following is occur:

If the payment code screen is open and the phone is unlocked, a notification must pop up stating “Payment code for [Merchant] has expired. Please use the merchant list to generate a new payment code.” When the user dismisses the notification, the application returns the user to the merchant list screen.

If the user is in another application or the phone is locked, a notification must be generated stating “Payment code for [Merchant] has expired. Please use the merchant list to generate a new payment code.” When the user reopens the application, the application must return the user to the merchant list screen.

Once the user has a payment code and is ready to complete their purchase with the merchant, the user will present their phone (displaying the payment code) to the merchant to scan.

Once the merchant scans the payment code, the merchant has to confirm the purchaser. See MM (Merchant Mobile) requirements.

Once the merchant confirms the customer and enters the purchase amount, a confirmation screen is generated for the customer on their application.

The customer confirmation screen displays the following: Merchant name

Purchase amount (format=dollar sign [$] followed by amount including two decimal places)
Purchase date/time (format=MM/DD/YYYY
A “Confirm Purchase” button must be available for selection by the customer.
Above the “Confirm Purchase” button, the following text must be displayed: “I authorize Alias Identity to complete the transaction with the merchant for the amount displayed above on my behalf.”
Cancel button.

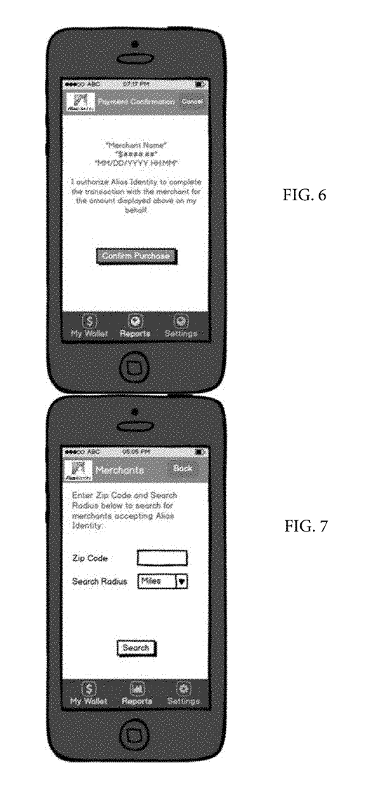

Mock up of the customer confirmation screen: See FIG. 6.

The Customer Confirmation screen includes a cancel button.

The cancel button on the Customer Confirmation screen terminates the transaction and send a message to the merchant. The user is returned to the Merchant List screen.

Once the user selects “confirm purchase” a confirmation pop up is generated stating “Transaction Successful.”

Once the user dismisses the “Transaction Successful” notification, the user is returned to the application landing page.

A link on the Merchant List screen allows users to search by zip code if they want to identify merchants in another location than their GPS location. (Users would use this option if no results are generated due to poor GPS signal or GPS is turned off.)

The fields on the Merchant Search screen includes:

Mile Radius—drop down with selection for 5, 10, 25 and 50 miles.
Zip Code—text box only allowing five digit number to be entered.

Mock up of the Merchant Search screen: See FIG. 7.

The results of the Merchant Search screen mirrors the Merchants List screen.

A “View on Map” option is provided on the Merchant List screen.

When the user select on the “View on Map” link, a new screen will be displayed with a map of all merchants listed in the Merchant List screen.

The map displays a map marker icon for the location of each merchant.

If the user selects on of the merchants on the map, a pop up displays with the following information.

### Merchant Name

### Merchant Address (Street Number, Street Name, City, State, Zip

### Merchant Phone Number

The information displayed in the pop up on the map specific for the merchant is populated from the merchant database

The pop up disappears if the user taps outside of the pop up.

The map screen has a back button that returns the users to the Merchant List screen.

The pop up allows the user to select the merchant to generate a payment code (same functionality if the user was selected from the list).

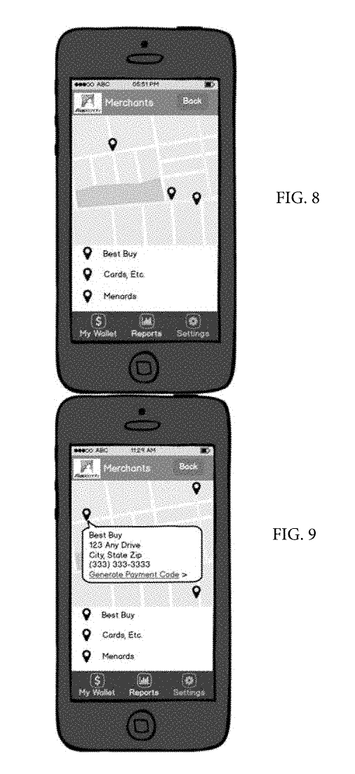

Mock up of the Merchant Map Screen: See FIG. 8.

Mock up of the Merchant Map Screen with pop up for a merchant: See FIG. 9.

### My Wallet Option

Once the user selects the My Wallet option from the landing page of the application, a screen with the following information appears:

### Wallet Balance

### Transaction Summary

The My Wallet option has a “Back” option.

The “Back” option returns the user to the landing page of the application.

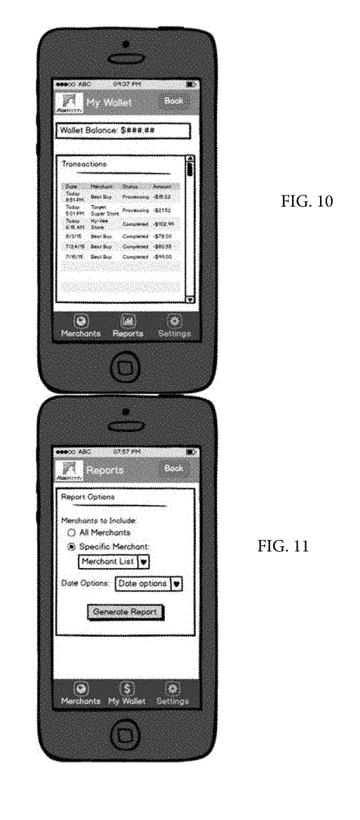

Mock up of the My Wallet option: See FIG. 10.

A scroll bar is expected on the transaction summary.

The Wallet Balance is expected to display the current wallet balance as of when the user selects the My Wallet option.

The Transaction Summary includes the following columns:

### Date

### Merchant

### Status

### Amount

The Date in the Transaction Summary is formatted as MM/DD/YY unless the transaction was made on the same calendar day as when the summary is being viewed.

In the case where the transaction is being viewed on the same calendar day as the transaction occurred, the Date in the transaction summary is displayed as “Today HH:MM [AM/PM]”.

The Merchant in the Transaction Summary display the name of the merchant where the transaction was made.

The Status in the Transaction Summary display one of the following statuses:

Processing—used when the transaction has been initiated but is not complete.
Completed—used when the transaction has been successfully completed.

The Amount in the Transaction Summary display the transaction amount in the format of $###.## with two decimals.

Purchases display as negative amounts in the Amount field in the Transaction Summary. Any returns/refunds for the customer must appear as positive amounts.

### Reports Option

The Reports option in the mobile application for the customer provides the same report options as online on the website.

The first page of the Reports option presents the user with the “Report Options” menu.

The Report Options menu must provide the following options: Merchants to Include

### Date Options

The Merchants to Include selection is a radio button with one of the following two options:

### All Merchants

### Specific Merchant.

The Specific Merchant option provides a drop down of all merchants the user has transactions with in either Completed or Processing status.

The Date Options option provides a drop down with the following date options:

### By Month

### By Year

Under the Report Options a “Generate Report” button is available. The button must be shaded in green.

A Back button is available in the header for the user to return to the main menu.

Mock up of Reports page one: See FIG. 11.

If the user selects All Merchants in the report options, transactions for the selected time period are included in the report.

If the user selects a specific merchant, only transactions for the selected merchant in the selected time period will be included in the report.

The report generated is a bar graph with the date (either months or years) displayed on the x-axis and dollar amounts on y-axis.

The report will not provide a transaction count on the graph.

The y-axis label provides dollar amounts without decimals and start at zero.

The report has a header in the following format: Report of Transactions at [All Merchants or Specific Merchant Name] by [Month or Year].

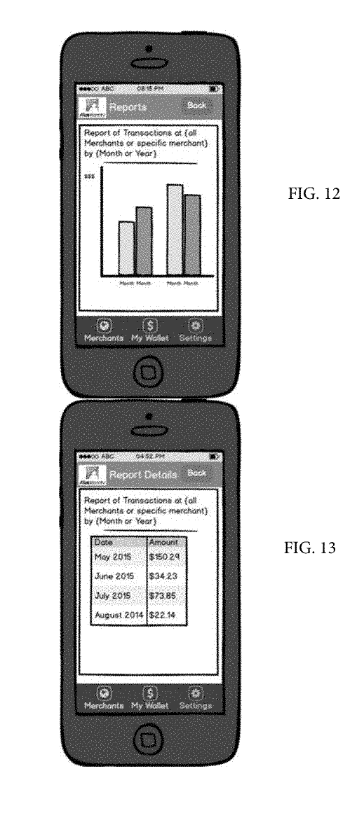

Mock up of Reports page 2: See FIG. 12.

The Back button on the Reports page 2 returns the user to the Reports Options page.

If the user taps on the bar graph, a new page (Reports Page 3) will be generated to provide details. The new page must have the details from the graph in a table format.

Reports Page 3 has a table with the values from the graph in the following format:

X-axis labels
Y-axis values

### Date

### Value

### Date

### Value

Reports Page 3 have the same header as the Reports Page 2.

A back button is present on the Reports Page 3 which would return users to Reports Page 2.

Mock up of Reports Page 3: See FIG. 13.

### Settings Option

The Settings menu has the following options:

### Notifications

### My Profile

### About

### Log Out

The Settings Menu displays all available options and provide a Home button.

The Home button returns users to the application main menu.

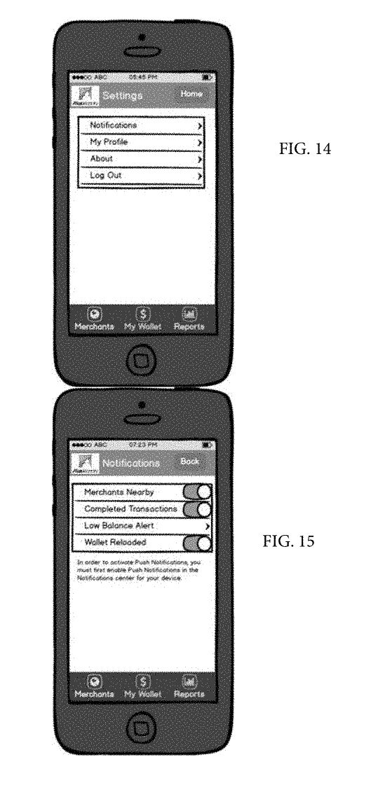

Mock up of the Settings menu: See FIG. 14.

The Notifications Menu has the following options with an on/off switch, except for Low Balance Alert.

### Merchants Nearby

### Completed Transaction

### Low Balance Alert

### Wallet Reloaded

The Notifications Menu has a Back option which returns users to the main Settings menu.

The Merchants Nearby Notification does generate a notification for users when the GPS is turned on and the user is within 1 mile of a merchant that accepts Alias Identity.

The Merchants Nearby Notification does state: “You're close to [Merchant Name]. Open Alias Identity to complete a purchase.”

The Merchants Nearby Notification provides users two options:

Open (opens Alias Identity to the Merchants option)
Dismiss (closes notification and does not change the phone's current state.

The Merchants Nearby Notification is defaulted to ON.

The Completed Transaction Notification generates a notification for users when a transaction status changes to “Completed” from “Processing”.

The Completed Transaction Notification states: “Purchase at [Merchant] on [MM/DD] successfully completed.”

The Completed Transaction Notification provides users two options:

Open (opens Alias Identity to My Wallet display of transactions)

Dismiss (closes notification and does not change the phone's current state.

The Completed Transaction Notification is defaulted to ON.

The Low Balance Alert option in the Notifications provides a new screen for the user with the following options:

Low Balance Alert (on/off) option.
Text “Get an alert when the balance falls below:”
Numeric field for a dollar amount.

The Low Balance Alert is defaulted to ON.

The numeric field for the dollar amount is defaulted to $100 and must not allow decimals.

The numeric field for the dollar amount is only be editable if the Low Balance Alert is set to ON. If the Low Balance Alert is set to OFF, the user cannot edit the amount.

The Wallet Reloaded Notification states: “Wallet has been reloaded successfully.”

The Wallet Reloaded Notification provides users two options:

Open (opens Alias Identity to My Wallet display of transactions)
Dismiss (closes notification and does not change the phone's current state.

The following text is displayed under the Notifications menu: “In order to activate Push Notifications, you must first enable Push Notifications in the Notifications center for your device.”

Mock up of the Notifications Settings: See FIG. 15.

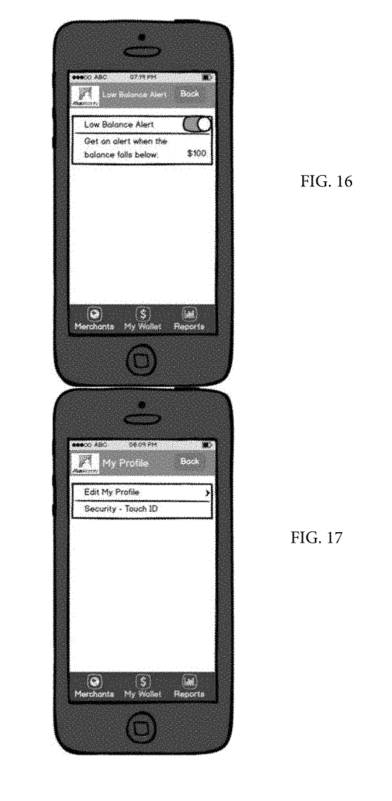

Mock up of the Low Balance Alert Screen: See FIG. 16.

The My Profile settings option opens a new page with the following options:

### Edit My Profile

### Security—Touch ID

Mock up of the My Profile settings menu: See FIG. 17.

The Security-Touch ID option allows users to enable or disable the ability to log into the application with their fingerprint. Enabled: User only has to use fingerprint to log into application Disabled: User must log in with username and password.

The About link from the Settings Menu displays the following information:

Application Version Number: Text stating Version ####.
Agreements: Link to list of agreements
Feedback: Link to text box

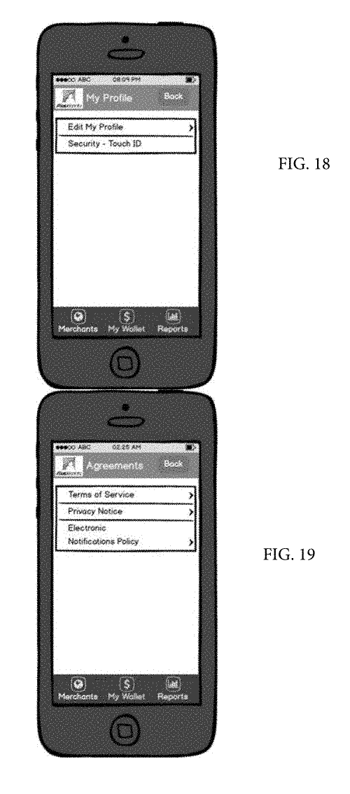

Mock up of the About Menu: See FIG. 18.

The Agreements hyperlink must populate a new screen with links to the following items:

### Terms of Service

### Privacy Notice

### Electronic Notifications Policy

The selection of any hyperlinks in the Agreements menu generates the text of the selected agreement in a new page.

There is a Back button on the Agreements menu, returning the user to the About menu.

There is a Back button on any page displaying text of the selected agreements so the user can return to the Agreements menu.

Mock up of the Agreements Menu: See FIG. 19.

The Feedback option generates a new screen with a back button.

The Feedback option creates the following in the new screen: Text at top: “How can we make this app better? Provide feedback below.” Free form text box limited to 300 characters.

Submit button.

The submit button generates a log of the feedback and provide it to Alias Identity.

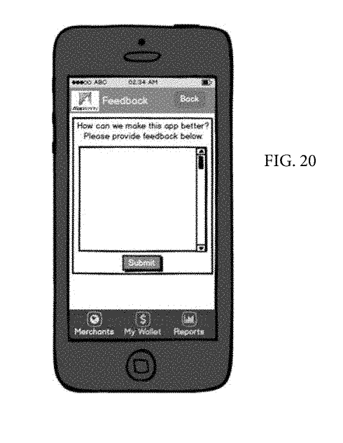

Mock up of Feedback option: See FIG. 20.

The Logout link from the Settings Menu logs the user completely out of the application when selected.

After the user selects the Logout link from the Settings Menu log in screen for the application is displayed.

Customer removal from the internet with the Invention

1. The customer signs up on the internet on the Exchange Server (112).

2. The Exchange Server (112) creates a call to the Alias Process Server (120).

3. The Alias Process Server (120) starts the removal of the customer from the internet by calling the information and the Exchange Server (112) sends the customer's name and email address to the Threat Server (126) through its internet connection to the Threat Server (126).

4. The Threat Server (126) cleans the information and prepares the information to be sent to the Alias Process Server (120). The Threat Server is connected to Air Gap 1 (127).

5. The Air Gaps (127, 128) are made up of two USB hubs (122) and one mechanical robotic device (124). The USB hubs (122) are attached to the Threat Server (126) by an inbound connection UP1 and an outbound connection UP0. The Hub is controlled by software that will take information and store it on USB drives (129) with drive designations D0 through D3 as outbound information collection on a USB drive (129) and D4 through D7 as plug ins for inbound information.

6. Once the name and the email address is on the Threat Server (126) it is passed to the UP0 connection through the USB hub (122) and its software to a USB drive (129) that is inserted in one of the ports D0 through D3. Once the drive is 80% full it issues a command to the mechanical robotic device (124) to transfer the information from the USB hub (122) attached to the Threat Server (126) to the inbound port D4 through D7 on the hub that is attached to the Alias Server (120). The information is uploaded to the Alias Server (120) on UP1 to be processed and turned into an Alias identity.

7. The Alias Process Server (120) performs two programs with the information uploaded from the Transaction Server. It creates an alias identity for the information and assigns a key code to the Alias Identity. When this is done, the Alias Process Server (120) creates a call for the first Splinter of information from the consumer wanting to join EZgopay.

8. The second program, the Alias Process Server (120), runs is to download the original name and email address through Air Gap 2 (128) to the Transaction Process Server (130). The Alias Process Server (120) sends the information through the UP0 hub to a USB mounted in D4 through D7. Once the USB drive (129) is 80% full, it triggers the mechanical robotic device (124) to remove it and insert it into port D0 through D3 on the USB hub (122) connected to the Transaction Process Server (130). The Transaction Process Server (130) uploads the information from UP1 into the Transaction Process Server (130) and creates the real identity for the consumer with the consumer's key code for synchronizing future inbound information to create the consumer off the grid for financial transactions.

9. Once the Alias Process Server (120) has passed the customer name and email address through the hub to the Transaction Process Server (130), it calls for the first Splinter of information and assigns a key code which is the same the key code of the consumer for which it requesting the splinter. The Splinter of information is collected randomly from the consumer's email or text messaging. The first piece of information once collected from the Internet Mail Server (110), is transmitted to the Alias Process Server (120) using steps 1 through 6 when the Alias Process Server (120) reads the key code it sends the information to the Transaction Process Server (130) using steps 7 and 8. This process continues until 10 random pieces of information are collected and stored on the Transaction Process Server (130).

10. Once the 10 pieces of information are collected and stored on the Transaction Process Server (130) using the unique key codes to synchronize the information and create a real individual on the Transaction Process Server (130) completely removed from the web, the Transaction Process Server (130) then tells the Alias Process Server (120) to create an Identicon for the consumer which is made up of a unique graphical component when a financial is requested and a textual component. The textual component contains the encrypted original key code of the consumer, a time stamp, a geo-location and transaction number. The Identicon is transmitted to the Internet Exchange Server (112) where it is synchronized to the consumer's photo which has been residing on the Internet Exchange Server (112). The consumer is now ready to make a financial transaction using their Identicon.

This method of collection and removal of the consumer's information behind our two Air Gaps (127, 128) assures that financial transactions for a consumer that has been removed from the internet through the process are secure from hacking. If the Identicon for the consumer is hacked, the hacker only gets a random number generated by the system, a graphical representation which has no tie to the consumer and is computer generated each time the consumer requests a financial transaction.

The above description can be modified without departing from the scope of the claims.

1. A method of encrypting an identity for financial transactions including:
creating an Alias Identity in the form of an Identicon on an alias computer server with both a graphical component and a textual component.
creating a hardware firewall between an internet server and the alias computer server;
creating a software firewall between the internet server and the alias computer server;
creating air gaps between the internet server and the alias computer server.
utilizing the alias in financial transactions with a financial institution.
creating the graphical component as a 3² token;
sending the 3² token with a mobile device to a merchant;
displaying the alias for the identity when the merchant scans the 3² token; and
the merchant visually approving the alias.

2. The method of claim 1, including:
generating the identity from the alias; and
a financial institution debiting an account assigned to the identity.

3. The method of claim 2, wherein the alias is created with splinters of information from random events through a plurality of electronic devices.

4. A system of encrypting an identity for financial transactions including:
an alias computer server configured to create an alias for the identity with both a graphical component and a textual component;
a threat server configured to encrypt the alias with splinters of information from random events through a plurality of electronic devices;
a hardware firewall between an internet server and the threat computer server;
a software firewall between the internet server and the threat computer server; and
a plurality of air gaps between the internet server and the alias computer server.

5. The system of claim 4, wherein the alias is utilized in financial transactions with a financial institution.

6. The system of claim 5, including:
the graphical component configured as a quick response token;
a mobile device configured to send the quick response token to a merchant; and
an electronic device display configured to display the alias for the identity when the merchant scans the quick response token.

7. The system of claim 6, wherein the alias server is configured to
generate the identity from the alias.

8. A system of encrypting an identity for financial transactions including:
an email server configured to collect information regarding the identity;
an alias computer server configured to create an alias for the identity with both a graphical component and a textual component,
a threat server configured to encrypt the alias with splinters of information from random events through a plurality of electronic devices;
a hardware firewall and a software firewall disposed between an internet server and the threat server;
a transaction server configured to complete a financial transaction request received from the alias server; and
at least one air gap between the internet server and the threat server, and at least one air gap disposed between the alias server and the transaction server.
